(19) United States
(12) Patent Application Publication
(10) Pub. No.: US 2024/0034066 A1
(43) Pub. Date: Feb. 1, 2024

(54) ABSORBER, LIQUID RECEIVER, AND LIQUID DISCHARGE APPARATUS

(71) Applicants: Hiromi KODAMA, Kanagawa (JP); Yukiko ISHIJIMA, Kanagawa (JP)

(72) Inventors: Hiromi KODAMA, Kanagawa (JP); Yukiko ISHIJIMA, Kanagawa (JP)

(21) Appl. No.: 18/220,827

(22) Filed: Jul. 12, 2023

(30) Foreign Application Priority Data
Jul. 29, 2022 (JP) 2022-122064
Mar. 28, 2023 (JP) 2023-051909

(51) Int. Cl. B41J 2/165

(52) U.S. Cl. CPC B41J 2/16517

(57) ABSTRACT

An absorber for absorbing liquid discharged from a liquid discharge head includes three or more laminated layers. The three or more laminated layers include an uppermost layer, a lowermost layer, and an inner layer. The uppermost layer of nonwoven fabric has through holes that penetrate through the uppermost layer in a lamination direction in which the laminated layers are laminated. The lowermost layer of nonwoven fabric has through holes that penetrate through the lowermost layer in the lamination direction. The inner layer is between the uppermost layer and the lowermost layer and has a porous structure higher in liquid absorption capacity than each of the uppermost layer and the lowermost layer.

### CROSS-REFERENCE TO RELATED APPLICATIONS

This patent application is based on and claims priority pursuant to 35 U.S.C. § 119(a) to Japanese Patent Application Nos. 2022-122064, filed on Jul. 29, 2022, and 2023-05190), filed on Mar. 28, 2023, in the Japan Patent Office, the entire disclosure of each of which is hereby incorporated by reference herein.

### BACKGROUND

### Technical Field

Embodiments of the present disclosure relate to an absorber, a liquid receiver, and a liquid discharge apparatus.

### Related Art

For example, a printer as a liquid discharge apparatus may perform dummy discharge as a maintenance operation of a liquid discharge head. In the dummy discharge (including operations called, e.g., flushing and purging), the printer discharges liquid that does not contribute to printing into a dummy discharge receptacle including an absorbing member.

Currently, the viscosity of ink used in such a printer is higher, which may cause a problem that ink is deposited on an absorber that absorbs flushing droplets. As a result, the deposited ink may contaminate a recording medium. For this reason, in order to enhance the absorption capacity of the absorber, there have been proposed techniques such as providing a void in the absorber and providing a laminated structure of absorbers having different degrees of fusion.

### SUMMARY

According to an embodiment of the present disclosure, an absorber for absorbing liquid discharged from a liquid discharge head includes three or more laminated layers. The three or more laminated layers include an uppermost layer, a lowermost layer, and an inner layer. The uppermost layer of nonwoven fabric has through holes that penetrate through the uppermost layer in a lamination direction in which the laminated layers are laminated. The lowermost layer of nonwoven fabric has through holes that penetrate through the lowermost layer in the lamination direction. The inner layer is between the uppermost layer and the lowermost layer and has a porous structure higher in liquid absorption capacity than each of the uppermost layer and the lowermost layer.

According to another embodiment of the present disclosure, a liquid receiver includes the absorber. The absorber is divided.

According to still another embodiment of the present disclosure, a liquid receiver includes the absorber, a holder, and a container. The holder is below and in contact with the lowermost layer. The container accommodates the absorber and the holder. The absorber is divided, and absorbs the liquid with the absorber and the holder accommodated in the container.

According to still yet another embodiment of the present disclosure, a liquid receiver includes the absorber and a holder. The holder is below and in contact with the lowermost layer. The holder includes metal and is subjected to anti-rust treatment. The holder has a claw to fix the absorber from a side face of the absorber.

According to still yet further another embodiment of the present disclosure, a liquid discharge apparatus includes the absorber and a liquid discharger to discharge liquid.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings. wherein:

FIG. 1 is a schematic view of the configuration of a printer illustrated as a liquid discharge apparatus according to an embodiment of the present disclosure:

FIG. 2 is a plan view of a printing unit of the printer of FIG. 1;

FIG. 3 is a side view of the printing unit of FIG. 2;

FIG. 4A is a schematic cross-sectional view of an absorber according to an embodiment of the present disclosure; FIG. 4B is a schematic cross-sectional view of an absorber according to an embodiment of the present disclosure;

FIGS. 5A and 5B are schematic cross-sectional views of absorbers having different thicknesses of inner layers, according to embodiments of the present disclosure;

FIGS. 5C and 5D are schematic cross-sectional views of absorbers different in thickness of inner layer, according to embodiments of the present disclosure;

FIGS. 6A, 6B, and 6C are schematic cross-sectional views of absorbers different in thickness of uppermost layer and lowermost layer, according to embodiments of the present disclosure;

FIGS. 6D, 6E, and 6F are schematic cross-sectional views of absorbers different in thickness of uppermost layer and lowermost layer, according to embodiments of the present disclosure:

FIG. 7A is a schematic cross-sectional view of an absorber having holes in an inner layer, according to an embodiment of the present disclosure; FIG. 7B is a schematic cross-sectional view of an absorber having holes in inner layers, according to an embodiment of the present disclosure:

FIGS. 8A, 8B, and 8C are schematic cross-sectional views of absorbers different in depth of holes in an inner layer, according to embodiments of the present disclosure:

FIGS. 8D, 8E, and 8F are schematic cross-sectional views of absorbers different in depth of holes in an inner layer, according to embodiments of the present disclosure;

FIGS. 9A, 9B, and 9C are schematic cross-sectional views of absorbers different in opening ratio of through holes in an inner layer, according to embodiments of the present disclosure;

FIGS. 9D, 9E, and 9F are schematic cross-sectional views of absorbers different in opening ratio of through holes in an inner layer, according to embodiments of the present disclosure:

FIGS. 10A, 10B, and 10C are schematic cross-sectional views of absorbers different in size of holes in an inner layer, according to embodiments of the present disclosure;

FIGS. 10D, 10E, and 10F are schematic cross-sectional views of absorbers different in size of holes in an inner layer, according to embodiments of the present disclosure;

FIGS. 11A, 11B, and 11C are schematic cross-sectional views of absorbers different in arrangement of through holes and holes, according to embodiments of the present disclosure;

FIGS. 12A and 12B are schematic perspective views of a liquid receiver according to an embodiment of the present disclosure;

FIG. 13 is a schematic perspective view of a holder according to an embodiment of the present disclosure;

FIG. 14 is a schematic cross-sectional view of a liquid receiver according to an embodiment of the present disclosure;

FIG. 15 is a schematic perspective view of an absorber according to an embodiment of the present disclosure, illustrating an example of replacement;

FIG. 16A is a schematic plan view of an absorber according to an embodiment of the present disclosure, illustrating an example of arrangement; and

FIG. 16B is a schematic side view of the absorber of FIG. 16A.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

Hereinafter, an embodiment of the present disclosure applied to a color laser printer (hereinafter, simply referred to as a printer) that is an image forming apparatus will be described.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Below, an absorber, a liquid receiver, and a liquid discharge apparatus according to embodiments of the present disclosure are described with reference to the drawings. Embodiments of the present disclosure are not limited to the embodiments described below and may be other embodiments than the embodiments described below. The following embodiments may be modified by, for example, addition, modification, or omission within the scope that would be obvious to one skilled in the art. Any aspects having advantages as described for the following embodiments according to the present disclosure are included within the scope of the present disclosure.

According to an embodiment of the present disclosure, an absorber absorbs liquid discharged from a liquid discharge head. The absorber includes three or more laminated layers. An uppermost layer of the laminated layers is made of nonwoven fabric and has a through-hole penetrating the uppermost layer in a lamination direction in which the laminated layers are laminated. A lowermost layer of the laminated layers is made of nonwoven fabric and has a through-hole penetrating the lowermost layer in the lamination direction. An inner layer of the laminated layers has a porous structure having a higher liquid absorption capacity than each of the uppermost layer and the lowermost layer. According to one or more embodiments of the present disclosure, the maintainability in, for example, replacement of an absorber can be enhanced. In one or more embodiments of the present disclosure, the absorber may be referred to as, for example, a liquid absorber, an ink absorber, or a waste ink absorber. In one or more embodiments of the present disclosure, the absorber preferably absorbs a liquid that does not contribute to image formation.

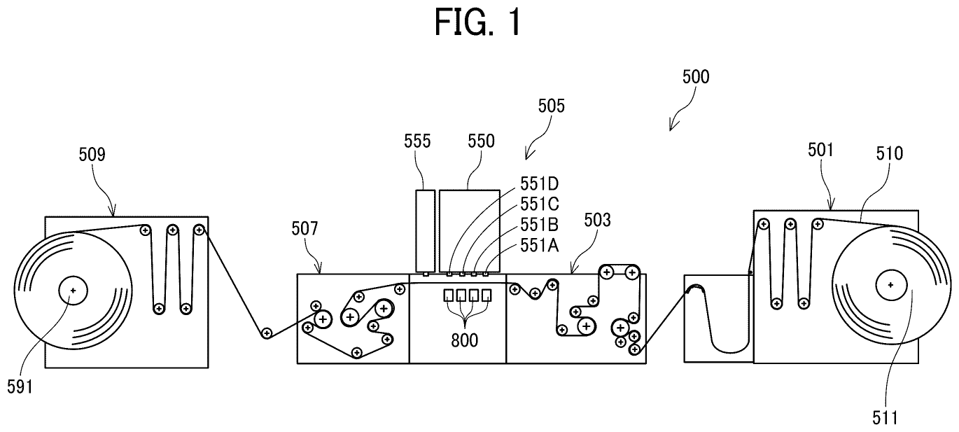

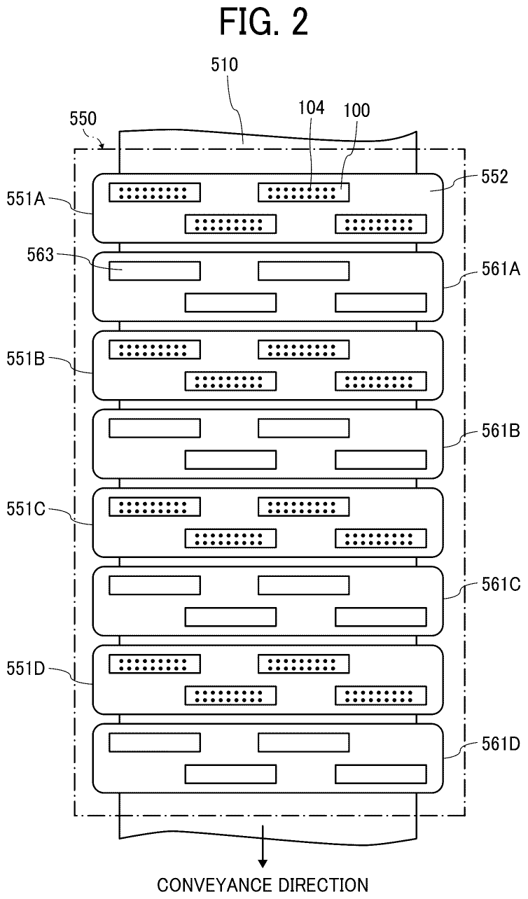

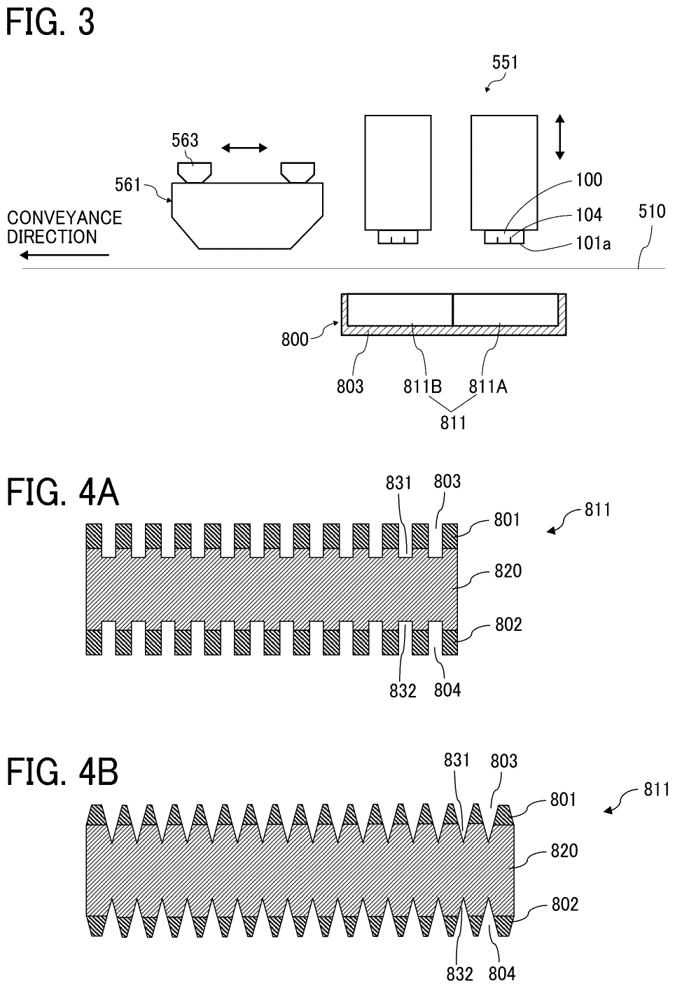

A printer as a liquid discharge apparatus according to the present embodiment is described with reference to FIGS. 1 to 3. FIG. 1 is a schematic view of the printer, illustrating an example of the configuration of the printer. FIG. 2 is a plan view of a printing unit of the printer of FIG. 1. FIG. 3 is a side view of the printing unit of FIG. 2.

A printer 500 as an example of the liquid discharge apparatus includes, for example, a feeder 501 to feed a sheet medium 510, such as a rolled sheet, a guide conveyor 503 to guide and convey the sheet medium 510, fed from the feeder 501, to a printing unit 505, the printing unit 505 to discharge liquid onto the sheet medium 510 to form an image on the sheet medium 510, a drier unit 507 to dry the sheet medium 510, and an ejector 509 to eject the sheet medium 510.

The sheet medium 510 is fed from a winding roller 511 of the feeder 501, guided and conveyed with rollers of the feeder 501, the guide conveyor 503, the drier unit 507, and the ejector 509, and wound around a take-up roller 591 of the ejector 509.

In the printing unit 505, the sheet medium 510 is conveyed so as to face the head unit 550 and the head unit 555, and an image is formed by liquid discharged from the head unit 550. Post-treatment may be performed with treatment liquid discharged from the head unit 555.

In the head unit 550, for example, full-line head arrays 551A, 551B. 551C, and 551D (hereinafter, collectively referred to as head arrays 551 unless distinguished) for four colors are arranged from the upstream side in a direction of conveyance of the sheet medium 510.

The head arrays 551K, 551C, 551M, and 551Y are liquid dischargers to discharge liquid of, for example, black (K), cyan (C), magenta (M), and yellow (Y) onto the sheet medium 510 conveyed. The types and the number of colors are not limited to the above-described example.

In each of the head arrays 551, for example, as illustrated in FIG. 2, multiple liquid discharge heads 100, which may be referred to as “heads”, are arranged in a staggered manner on a base 552. In each head 100, multiple nozzles 104 to discharge liquid are arranged in two rows in a staggered manner. However, the configuration of the head arrays 551 is not limited to such a configuration.

Maintenance units 561 (561A to 561D) to maintain the heads 100 are arranged between the head arrays 551. Each maintenance unit 561 includes, for example, caps 563 to cap nozzle surfaces 101a of the heads 100.

Each maintenance unit 561 is disposed to be movable back and forth in directions indicated by arrow D1 in FIG. 3. The head array 551 is disposed to be movable up and down in the vertical direction. When capping is performed, the head array 551 moves up, and the maintenance unit 561 moves below the heads 100. Further, the head arrays 551 move down and the nozzle surfaces 101a of the heads 100 are capped by the caps 563.

Below the head arrays 551 is disposed a dummy discharge receptacle 800 that receives dummy discharge droplets discharged from the nozzles 104 of the head 100.

The dummy discharge receptacle 800 is a liquid receiver according to an embodiment of the present disclosure. The liquid receiver includes an absorber according to an embodiment of the present disclosure. The absorber according to the present embodiment is suitably used in the case of absorbing liquid discharged from a liquid discharge head. Examples of the liquid discharged from the liquid discharge head include a liquid that does not contribute to image formation in addition to a liquid that contributes to image formation, and the absorber of the present embodiment is suitably used in the case of absorbing the liquid that does not contribute to image formation. For example, the absorber of the present embodiment receives dummy discharge droplets discharged from the nozzles 104 of the head 100 and absorbs the dummy-discharged liquid. Discharging liquid that does not contribute to image formation is referred to as dummy discharge, and dummy discharge includes operations referred to as, for example, flushing, purging, and idle discharge.

In addition, the absorber according to an embodiment of the present disclosure is not limited to the case of absorbing the liquid discharged from the liquid discharge head, but may absorb all the waste ink generated from the printer. The absorber of the present embodiment is suitable for absorbing waste ink of an inkjet image forming apparatus. However, the application of the absorber is not limited to an inkjet image forming apparatus. The liquid that does not contribute to image formation is also referred to as waste ink. The liquid may be, for example, ink.

The term “liquid” includes any liquid having a viscosity or a surface tension that can be discharged from the head. The “liquid” is not limited to a particular liquid and may be any liquid having a viscosity or a surface tension to be discharged from a head. However, preferably, the viscosity of the liquid is not greater than 30 mPa·s under ordinary temperature and ordinary pressure or by heating or cooling.

Examples of the liquid include a solution, a suspension, or an emulsion that contains, for example, a solvent, such as water or an organic solvent, a colorant, such as dye or pigment, a functional material, such as a polymerizable compound, a resin, or a surfactant, a biocompatible material, such as DNA, amino acid, protein, or calcium, or an edible material, such as a natural colorant. Such a solution, a suspension, or an emulsion can be used for, e.g., surface treatment solution, a liquid for forming components of electronic element or light-emitting element or a resist pattern of electronic circuit, or a material solution for three-dimensional fabrication, in addition to the above-described inkjet ink.

Below, absorbers according to some embodiments of the present disclosure are described with reference to the drawings.

According to an embodiment of the present disclosure, an absorber includes three or more laminated layers. An uppermost layer of the laminated layers is made of nonwoven fabric and has a through-hole penetrating the uppermost layer in a lamination direction in which the laminated layers are laminated. A lowermost layer of the laminated layers is made of nonwoven fabric and has a through-hole penetrating the lowermost layer in the lamination direction. An inner layer of the laminated layers has a porous structure having a higher liquid absorption capacity than each of the uppermost layer and the lowermost layer.

FIGS. 4A and 4B are schematic cross-sectional views of absorbers according to embodiments of the present disclosure. The absorbers illustrated in FIGS. 4A and 4B are different from each other in the shapes of the through holes 803 and 804. The absorber 811 according to the present embodiment is formed by laminating an uppermost layer 801, an inner layer 820, and a lowermost layer 802. The inner layer may be a single layer or multiple layers. When the inner layer is a single layer, the inner layer is described or illustrated as the inner layer 820.

<Layer Materials and Others>

The uppermost layer 801 and the lowermost layer 802 are non-woven fabrics and have the through holes 803 and 804 penetrating the layers in the lamination direction. The through hole in the uppermost layer 801 is denoted as the through hole 803, and the through hole in the lowermost layer 802 is denoted as the through hole 804. In FIG. 4A, the through holes 803 and the through holes 804 have a columnar shape. In FIG. 4B, the through holes 803 and the through holes 804 have a conical shape. The shapes of the through holes are not limited to the columnar shape and the conical shape and may be any other suitable shape. The shapes of the through holes may be the same or a mixture of multiple shapes.

In the following description, the uppermost layer 801 and the lowermost layer 802 may be referred to as sheet layers. When the term “sheet layers” is used, the uppermost layer 801 and the lowermost layer 802 are described without distinction. In the case where numerical specifications are given for the sheet layers, unless otherwise specified, it means that the uppermost layer 801 and the lowermost layer 802 preferably satisfy the numerical specifications.

The nonwoven fabric constituting the uppermost layer 801 and the lowermost layer 802 may be any appropriately-selected nonwoven fabric. For example, a synthetic fiber sheet, a thermal-bond nonwoven fabric, a spunbond nonwoven fabric, or an air-laid nonwoven fabric can be used. The uppermost layer 801 and the lowermost layer 802 may be the same type of nonwoven fabric or different types of nonwoven fabric.

The uppermost layer 801 and the lowermost layer 802 may be a synthetic fiber sheet rich in bulkiness. Examples of the synthetic fiber sheet rich in bulkiness include a synthetic fiber sheet which is made bulky by processing and has a texture like wool yarn. The synthetic fiber sheet rich in bulkiness has a relatively coarse mesh, thus allowing liquid to quickly transmit to the inner layer. Thus, liquid can be less likely to accumulate in the uppermost layer 801 and the lowermost layer 802. As a result, even when drying and permeation of liquid are repeated, the absorption speed of liquid is high, and a stable absorption effect is exhibited.

Since the uppermost layer 801 has the through holes 803, liquid in the uppermost layer 801 easily permeates into the inner layer. In the case where the uppermost layer 801 does not have the through holes 803, liquid in the uppermost layer 801 does not easily penetrate into the inner layer, dries on the surface of the absorber 811, and is deposited on the surface of the uppermost layer 801. In this case, the liquid absorption capacity of the absorber 811 is reduced.

Since the lowermost layer 802 has the through holes 804, the drying property of the lowermost layer 802 can be enhanced. The liquid penetrating the inner layer can be dried before the liquid reaches the lower part of the absorber 811. In the case where the lowermost layer 802 does not have the through holes 804, the drying property of the back of the absorber 811 (having the lowermost layer 802) decreases, and the liquid easily reaches the lower portion of the absorber 811. In this case, the storage container is easily contaminated with the liquid. Further, both sides of the absorber 811 may not be used.

Although the uppermost layer 801 and the lowermost layer 802 are separately described, the uppermost layer 801 and the lowermost layer 802 may be the lowermost layer and the uppermost layer respectively, of the absorber. In other words, both sides of the absorber 811 according to the present embodiment can be used. For this reason, the absorber 811 can be installed in the storage container without worrying about which surface is directed upward, thus allowing an increase in work efficiency. Such a configuration also contributes to enhancement in maintainability.

The method for forming the through holes is not limited to any particular method and may be any appropriately-selected method. For example, the through holes may be formed by piercing with a needle, or may be formed while melting with, for example, a heated needle. The through holes may be formed after the uppermost layer, the inner layer, and the lowermost layer are laminated, or may be formed before the uppermost layer, the inner layer, and the lowermost layer are laminated.

The inner layer has a porous structure with a higher liquid absorption capacity than each of the uppermost layer 801 and the lowermost layer 802. In this case, the liquid easily permeates from the uppermost layer 801 to the inner layer, and is unlikely to be accumulated in the lower portion of the lowermost layer 802. In the case where the liquid absorption capacity of the inner layer is equal to or less than the liquid absorption capacity of each of the uppermost layer 801 and the lowermost layer 802, liquid does not penetrate into the inner layer and is deposited on the surface of the uppermost layer 801. The liquid absorption capacity of the absorber 811 may be reduced. Further, when liquid is accumulated in a lower portion of the lowermost layer 802, the storage container is likely to be contaminated.

The liquid absorption capacity is measured in the following manner.

Two cc of a model ink (e.g., pigmented ink prepared based on the disclosure of Japanese Unexamined Patent Application Publication No. 2020-049937) is injected into one corner of one side of a test piece of 30 mm×150 mm, and drying of 70° for 24 hours is alternately repeated on both sides of the test piece, and the liquid absorption rate of the ink is measured each time. Measurement in this manner allows the liquid absorption capacity of the sheet layers (the uppermost layer and the lowermost layer) to be compared with the liquid absorption capacity of the inner layer.

In the case where the absorber includes multiple inner layers, the liquid absorption capacity of the multiple inner layers is determined assuming that the entire inner layers as one layer, and is compared with the liquid absorption capacity of the sheet layer. In the case where the absorber includes multiple inner layers, the liquid absorption capacity of each inner layer may be determined to calculate the average value of the liquid absorption capacities of the multiple inner layers. The average value may be compared with the liquid absorption capacity of the sheet layer. In the case where the absorber includes multiple inner layers, each one of the multiple inner layers preferably has a higher liquid absorption capacity than the sheet layer. In the case where the absorber includes multiple inner layers, however, all of the multiple inner layers have a porous structure.

In the present embodiment, when the absorber 811 is removed from the storage container, a hand or other components can be unlikely to be contaminated. In the present embodiment, when the absorber 811 is removed from the storage container, a hand or other components can be unlikely to be contaminated, thus allowing an increase in work efficiency. As a result, in the present embodiment, the maintainability can be enhanced. The case in which the absorber 811 is removed from the storage container is not limited to any particular case. Examples of the case in which the absorber 811 is removed from the storage container include the case in which the absorber 811 is replaced.

The configuration of the inner layer may be any appropriately-selected configuration having a porous structure.

The inner layer may include, for example, main support fibers, a heat-fusible substance, and a thickening substance. As the main support fibers, any natural cellulose fibers and synthetic fibers can be used. For example, wood pulp, linters, and other various non-timber fibers are included.

Examples of the heat-fusible substance include heat-fusible fibers and heat-fusible powder. The heat-fusible fibers and the heat-fusible powder may be mixed and used.

The heat-fusible fibers may be conjugate fibers in which polypropylene fibers (having a melting point of 160° C.) as a core portion are covered with a polyethylene layer (having a melting point of 130° C.) as a covering layer. When conjugate fibers are used, only the outer coating layer is melted by hot air applied at a temperature, for example, 140° C. at which the outer coating layer melts but the core portion does not melt. In this case, since the core portion is not melted and remains as stable fibers, a strong nonwoven fabric can be obtained.

As the thickening substance, a known thickening substance can be used. For example, carboxyl methyl cellulose (CMC), polyvinyl alcohol (PVA), sodium polyacrylate, or polyethylene oxide (PEO) is suitable. The thickening substances are excellent in that excellent thickening properties can be obtained with a small amount, and are also excellent in solubility in water at room temperature and low cost.

The inner layer preferably contains natural cellulose fibers, and each layer of multiple inner layers preferably includes natural cellulose fibers as main component. For example, in the case where the content is 30% by mass or more in each layer of the multiple inner layers, it can be said that each layer includes natural cellulose fibers as main component.

The inner layer is preferably a dry-laid nonwoven web comprising natural cellulose fibers or a dry-laid nonwoven mat comprising natural cellulose fibers. In this case, the liquid absorption capacity of the inner layer can be further increased, and the storage container can be further prevented from being contaminated with liquid.

The dry nonwoven fabric is prepared by drying fibers as a material of the nonwoven fabric, and the dry nonwoven fabric after preparation is distinguished from the wet nonwoven fabric. When a dry nonwoven fabric web or a dry nonwoven fabric mat is used for the inner layer, the inner layer more preferably includes natural cellulose fibers as main component.

The inner layer is preferably an air-laid nonwoven fabric. The air-laid nonwoven fabric is a nonwoven fabric produced by an air-laid production method. When the inner layer is produced by a production method other than the air-laid production method, for example, a thermal bond production method or a chemical bond production method, the fibers are arranged in the same direction. As a result, the absorber is likely to be fatigued by pressure applied from above. On the other hand, in the air-laid manufacturing method, the fibers are blown with air so that the directions of the fibers are randomly arranged and the thickness is further compressed. As a result, elasticity can be imparted to the absorber 811, the shape of the absorber 811 can be easily maintained, and the absorber 811 is less likely to be fatigued by pressure. Further, preparing the inner layer by an air-laid production method can enhance the durability.

Typically, in an air-laid production method, its constituent fibers are defiberized and conveyed in an air stream through a wire mesh or a screen having pores. Then, a web is formed by an air-laying method in which the fibers are dropped and deposited on a wire mesh. The intersections of the fibers in the web are bonded by a predetermined means such as thermal fusion bonding or thermal bonding. Alternatively, the air-laid nonwoven fabric can be produced by adding a heat-fusible substance (for example, a binder component) other than the fibers of the air-laid nonwoven fabric before or after the formation of the web, heating the heat-fusible substance to generate adhesiveness, and bonding or binding the fibers to each other.

Thus, the inner layer produced by the air-laid production method and the inner layer produced by a production method other than the air-laid production method can be distinguished from each other, for example, by the orientation of the fibers. In the inner layer produced by the air-laid production method, the fibers are oriented in different directions. In addition, in the inner layer produced by the air-laid production method, the intersections of fibers are bonded by heat, or the intersections of fibers are bonded by heat-fusible substance.

The uppermost layer 801 and the lowermost layer 802 are also preferably produced by an air-laid production method. In this case, as described above, elasticity can be imparted to the absorber 811, the shape of the absorber 811 can be easily maintained, and the absorber 811 is less likely to be fatigued by pressure. Further, preparing the inner layer by an air-laid production method can enhance the durability.

The inner layer preferably has an apparent density of 0.08 g/cm³ or more and 0.50 g/cm³ or less. When the apparent density of the inner layer is within this range, the inner layer can have a desired permeability to liquid in the inner layer. For example, before liquid permeates into the inside of the absorber 811 and permeates more than two-fifths of the thickness of the absorber 811, the permeation stops due to the dryness of the through holes 804 in the lowermost layer 802. As a result, liquid can permeate into the inner layer and can be prevented from reaching the lower portion of the absorber 811.

In the above description, the expression “at least two-fifths of the thickness of the absorber 811” means a point at least two-fifths of the thickness of the absorber 811 downward in the laminating direction from the point of the outermost surface of the uppermost layer 801. The same applies to the following similar description. Further, in the case where the inner layer includes multiple inner layers, the apparent density preferably satisfies the above-described range, assuming that the multiple inner layers are regarded as one layer.

In the case where the apparent density of the inner layer is smaller than 0.08 g/cm³, the number of voids is too large and the liquid excessively permeates into the absorber 811. For this reason, the drying property by the through holes 804 in the lowermost layer 802 does not catch up the permeation, and liquid permeates from the outermost surface of the absorber 811 to the depth of two-fifths or more of the thickness of the absorber 811.

In the case where the apparent density of the inner layer is larger than 0.50 g/cm³, the voids are too small, resulting in a decrease in liquid absorption capacity. For this reason, the liquid is less likely to penetrate from the outermost surface of the absorber 811 downward to the depth of one-fifth or more of the thickness of the absorber 811. Liquid dries and slightly accumulates on the surface of the absorber 811.

The apparent density was measured according to the apparent density measurement method of JIS K 6767: 1995.

<Thickness>

The thickness of the inner layer may be any appropriately-selected thickness, and preferably, for example, 4.5 mm or more. In this case, a desired permeability to liquid in the inner layer can be achieved. For example, before liquid permeates into the inside of the absorber 811 and permeates more than two-fifths of the thickness of the absorber 811, the permeation stops due to the dryness of the through holes 804 in the lowermost layer 802. As a result, liquid can permeate into the inner layer and can be prevented from reaching the lower portion of the absorber 811. Further, both sides of the absorber 811 can be used even during use, and the frequency of replacement can be reduced.

When the absorber includes multiple inner layers, the total thickness of the multiple inner layers is preferably 4.5 mm or more. The thickness of the inner layer is measured by any suitable method.

When the inner layer is thicker than 4.5 mm, liquid is less likely to penetrate from the outermost surface of the absorber 811 downward to the depth of one-fifth or more of the absorber 811. Liquid dries and slightly accumulates on the surface of the absorber 811.

The upper limit of the thicknesses of the inner layer may be any appropriately-selected value, but is preferably, for example, not more than 30 mm. In this case, the absorber and the liquid receiver can be prevented from increasing in size while retaining the liquid absorption capacity.

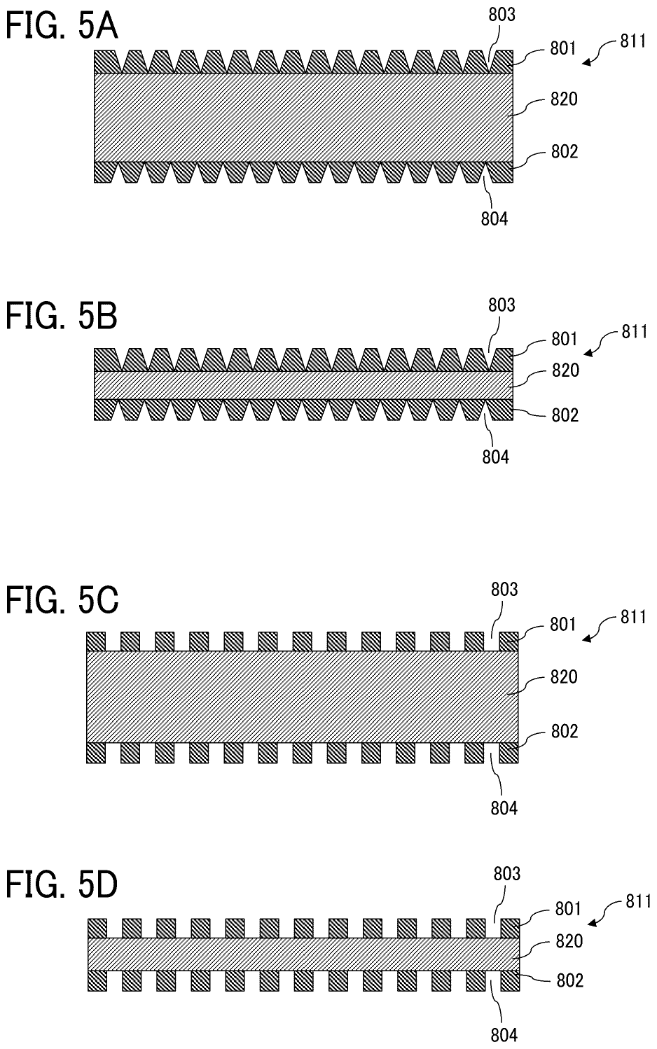

FIGS. 5A, 5B, 5C, and 5D are diagrams illustrating the thicknesses of the inner layer 820. FIGS. 5A and 5C illustrate cases where the inner layer 820 is relatively thick. FIGS. 5B and 5D illustrate cases where the inner layer 820 is thin.

The thickness of each of the uppermost layer 801 and the lowermost layer 802 may be any appropriately-selected thickness, and is preferably, for example, 0.3 mm or more and 0.8 mm or less. In this case, liquid can reach the inner layer. Further, liquid can be prevented from permeating downward to the depth of two-fifths or more of the thickness of the absorber 811.

In the case where the thicknesses of each of the uppermost layer 801 and the lowermost layer 802 is smaller than 0.3 mm, for example, the drying effect on the back surface (having the lowermost layer 802) of the absorber 811 decreases. As a result, liquid is likely to permeate downward to the depth of two-fifths or more of the thickness of the absorber 811.

In the case where the thickness of each of the uppermost layer 801 and the lowermost layer 802 is larger than 0.8 mm, liquid is less likely to penetrate downward to the depth of one-fifth or more of the thickness of the absorber 811. Liquid dries and slightly accumulates on the surface of the absorber 811.

The thickness of the uppermost layer 801 may be equal to or different from the thickness of the lowermost layer 802. The thicknesses of the uppermost layer 801 and the lowermost layer 802 are measured by any suitable method.

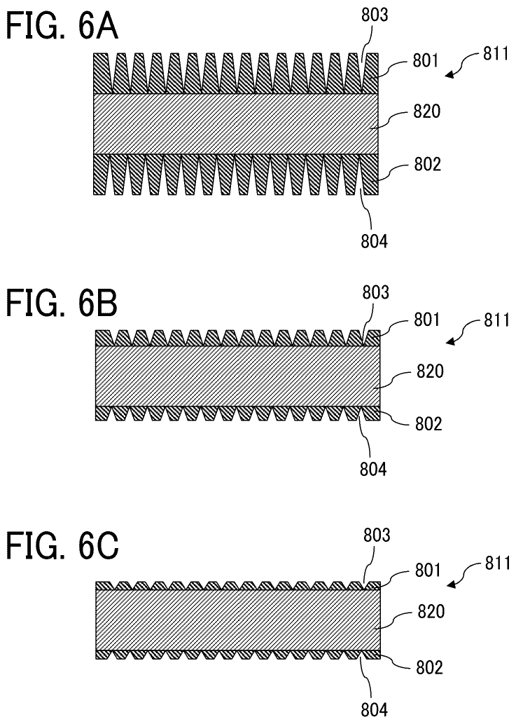

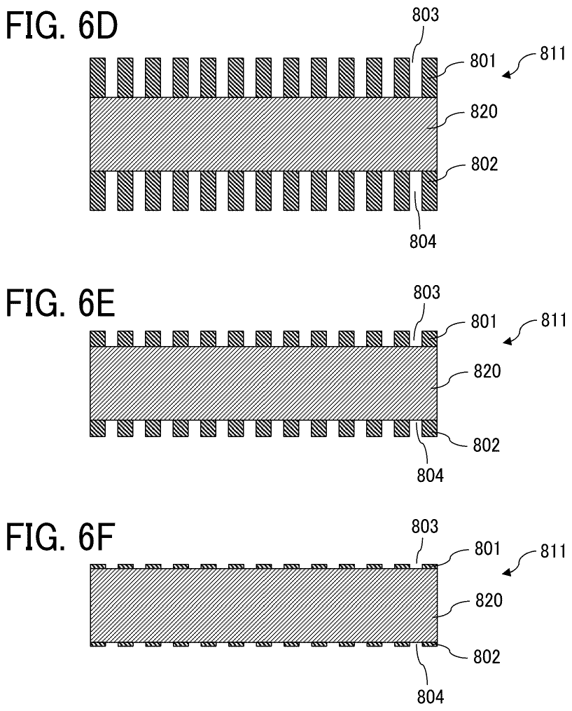

FIGS. 6A, 6B, 6C, 6D, 6E, and 6F are diagrams illustrating the thicknesses of the uppermost layer 801 and the lowermost layer 802. The thicknesses of the uppermost layer 801 and the lowermost layer 802 decrease in the order of FIGS. 6A, 6B, and 6C. Similarly, the thicknesses of the uppermost layer 801 and the lowermost layer 802 decrease in the order of FIGS. 6D, 6E, and 6F.

<Holes in Inner Layer>

The inner layer is preferably provided with holes, which may be referred to as recesses, on the surface facing the uppermost layer 801 and the surface facing the lowermost layer 802. The holes in the inner layer preferably do not penetrate through the inner layer and have a depth of one-third or less of the thickness of the inner layer. Providing the surface of the inner layer facing the uppermost layer 801 with the holes that do not penetrate through the inner layer can facilitate liquid to permeate from the uppermost layer 801 to achieve a targeted permeability for the liquid in the inner layer. In addition, the holes that do not penetrate through the inner layer are provided on the surface of the inner layer facing the lowermost layer 802, thus allowing enhancement of the drying property of the back surface of the absorber 811.

In the case where the depth of the hole in the inner layer is one-third or less of the thickness of the inner layer, liquid can easily permeate from the uppermost layer 801 to the inner layer, and can prevent liquid from permeating downward to the depth of two-fifths or more of the thickness of the absorber 811. Further, since liquid can be prevented from permeating downward to the depth of two-fifths or more of the thickness of the absorber 811, both sides of the absorber 811 can be interchangeably used even during use of the absorber 811. When the depth of the hole is larger than one-third of the thickness of the inner layer, liquid penetrates downward to the depth of two-fifths or more of the thickness of the absorber 811, thus hampering use of both sides.

In the case where both surfaces of the absorber 811 can be used, for example, in the case where liquid is deposited on the surface of the absorber 811, the absorber 811 is turned over to use the back surface, thus allowing continuous use. As a result, the absorber 811 can be used for a long period of time, thus allowing cost reduction.

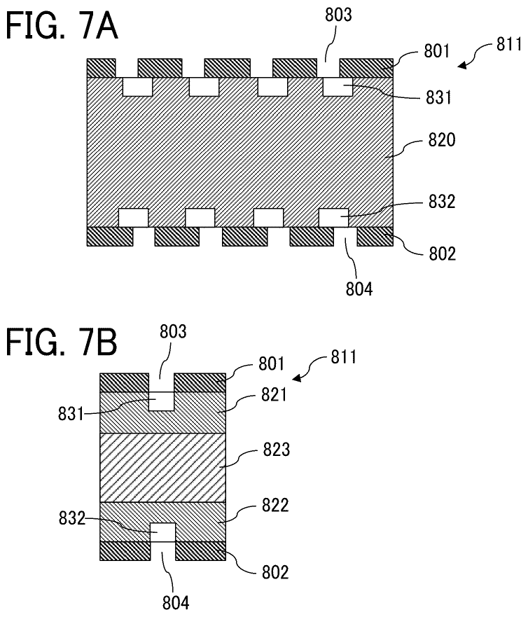

FIGS. 7A and 7B illustrate holes 831 and 832 included in the inner layer. FIG. 7A is a cross-sectional view of an absorber 811 including a single inner layer, according to an embodiment of the present disclosure. FIG. 7B is a cross-sectional view of an absorber 811 including multiple inner layers (three layers), according to an embodiment of the present disclosure.

For example, as illustrated in FIG. 7A, the inner layer 820 is provided with holes 831 on the surface facing the uppermost layer 801. The holes 831 have a depth at which the holes 831 do not penetrate through the inner layer 820. The holes 831 have a depth of one-third or less of the thickness of the inner layer 820.

Similarly, the inner layer 820 is provided with holes 832 on the surface facing the lowermost layer 802. The holes 832 have a depth at which the holes 832 do not penetrate through the inner layer 820. The holes 832 have a depth of one-third or less of the thickness of the inner layer 820. The depth of the holes 832 on the surface facing the lowermost layer 802 is a depth upward in the lamination direction of the layers.

As illustrated in FIG. 7B, in the case where the absorber 811 includes multiple inner layers, the holes 831 and 832 are also preferably provided. In the present embodiment, a layer in contact with the uppermost layer 801 is, for example, a first inner layer 821, a layer in contact with the lowermost layer 802 is, for example, a second inner layer 822, and a further inner layer is, for example, a third inner layer 823. In the absorber 811 illustrate in FIG. 7B, the first inner layer 821 has the holes 831 and the second inner layer 822 has the holes 832.

In the absorber 811 illustrate in FIG. 7B, the hole 831 has the depth at which the hole 831 does not penetrate through the first inner layer 821, and the hole 832 has the depth at which the hole 832 does not penetrate through the second inner layer 822. However, the depths of the holes are not limited to the above-described depths and may be any other suitable depths. The holes 831 and 832 preferably have a depth(s) at which the holes 831 and 832 do not penetrate through the inner layer. In the present embodiment, assuming the first to third inner layers as three inner sub-layers of one inner layer, the holes 831 and 832 preferably have a depth(s) at which the holes 831 and 832 do not penetrate through the entire inner layer. For this reason, even in the case where the holes 831 have a depth at which the holes 831 penetrate through the first inner layer 821, the depth is preferable if the depth is one-third or less of the thickness of the entire inner layer. The same applies to the holes 832.

In FIGS. 4A and 4B, the inner layer 820 of the absorber 811 includes holes 831 and 832. In the absorber 811 illustrated in FIGS. 4A and 4B, the holes 831 and 832 have a depth of one-third or less of the thickness of the inner layer 820.

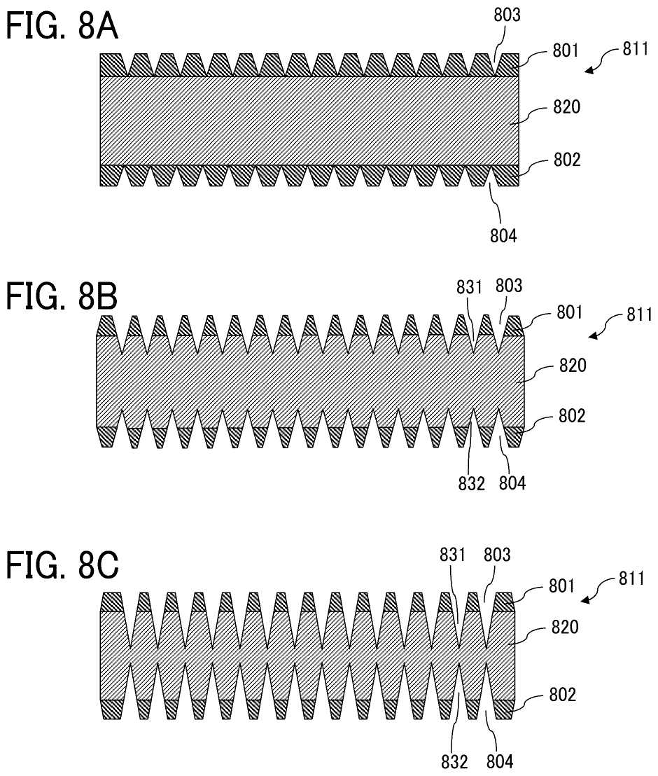

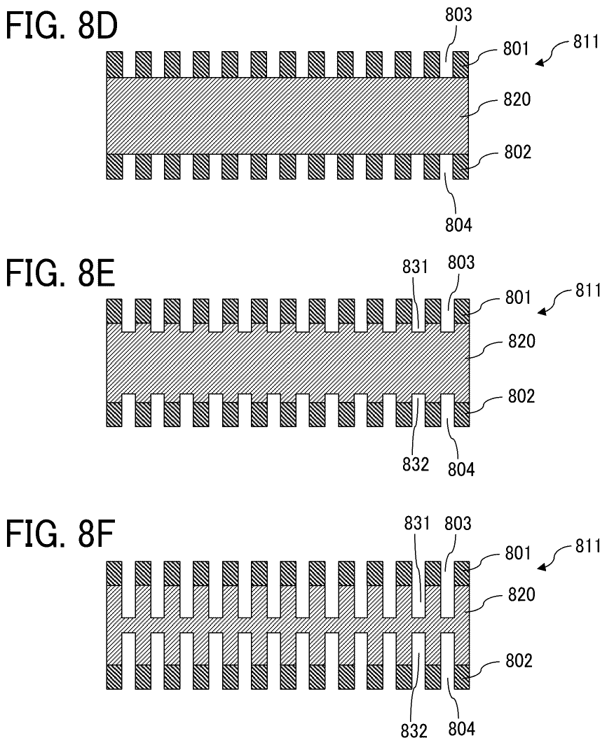

FIGS. 8A, 8B, 8C, 8D, 8E, and 8F are diagrams illustrating the depth of the holes 831 and 832.

FIGS. 8A and 8D each illustrate an absorber 811 in which an inner layer 820 does not have holes. FIGS. 8B and 8E each illustrate an absorber 811 in which an inner layer 820 has holes 831 and 832 whose depth is one-third or less of the thickness of the inner layer 820. FIGS. 8C and 8F each illustrate an absorber 811 in which an inner layer 820 has holes 831 and 832 whose depth is greater than one-third of the thickness of the inner layer 820.

Among the configurations illustrated in FIGS. 8A to 8F, the configurations of FIGS. 8B and 8E are preferable in that the holes 831 and 832 have depths of one-third or less of the thickness of the inner layer 820.

The method of forming the holes 831 and 832 is not limited to any particular method and may be any appropriately-selected method. The holes may be formed, for example, by piercing with a needle or by melting with a heated needle. Further, the holes 831 and 832 may be formed after the uppermost layer 801, the inner layer 820, and the lowermost layer 802 are laminated, or the holes 831 and 832 may be formed before the uppermost layer 801, the inner layer 820, and the lowermost layer 802 are laminated.

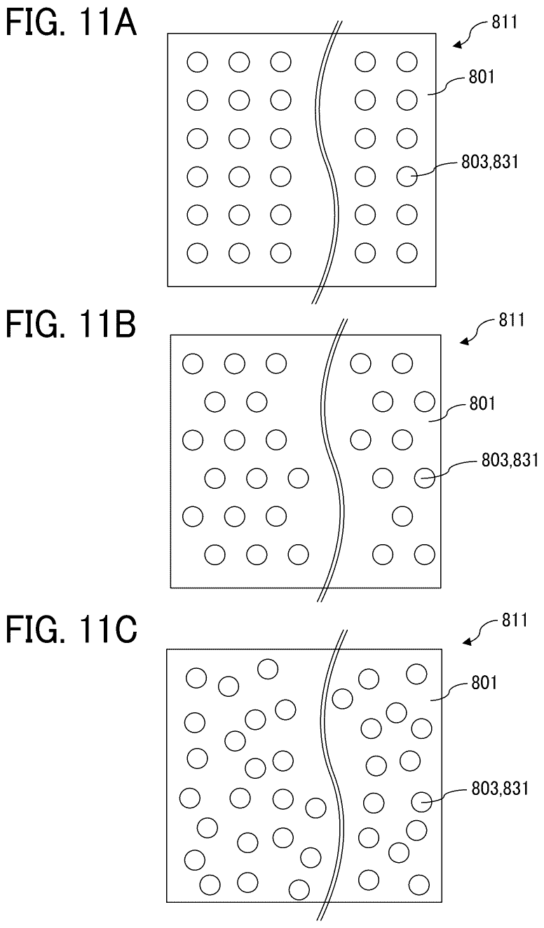

The shapes of the holes 831 and 832 may be circular as illustrated in FIGS. 11A to 11C or may be other shapes. Examples of the other shapes include, but are not limited to, a triangular shape, a quadrangular shape, and a star shape.

Further, the through holes 804 in the uppermost layer 801 and the holes 831 in the inner layer may be formed simultaneously, or the through holes 803 in the lowermost layer 802 and the holes 832 in the inner layer may be formed simultaneously. In the configurations illustrated in FIGS. 8A to 8F, the through holes 803 and the holes 831 are formed simultaneously, and the through holes 804 and the holes 832 are formed simultaneously. In the case where the through holes and the holes are formed simultaneously, the through holes and the holes can be easily located at the same positions.

The relative positions of the through hole 803 in the uppermost layer 801 and the hole 831 in the inner layer may be appropriately changed. However, the through hole 803 and the hole 831 are located at the same position. In this case, liquid easily permeates into the inner layer from the uppermost layer 801.

Similarly, the relative positions of the through holes 804 in the lowermost layer 802 and the holes 832 in the inner layer may be appropriately changed. However, the through hole 804 and the hole 832 are preferably located at the same position. In this case, the drying property of the back (the lowermost layer 802) of the absorber 811 can be enhanced.

In other words, the holes 831 in the surface of the inner layer facing the uppermost layer 801 are preferably located at the same positions as the through holes 803 of the uppermost layer 801, and the holes 832 in the surface of the inner layer on the lowermost layer 802 are preferably located at the same positions as the through holes 804 of the lowermost layer 802. Such a configuration can prevent liquid from penetrating to the back surface of the absorber 811 without impairing the absorption effect of the absorber 811. Further, both sides of the absorber 811 can be interchangeably used during use of the absorber 811. Furthermore, the replacement frequency and the running cost can be reduced.

In the above description, the same position is not limited to the case where the through hole and the hole completely match with each other, but includes the case where the through hole and the hole even partially overlap each other. For example, in FIG. 7A, the through hole 803 and the hole 831 partially overlap each other, and the through hole 804 and the hole 832 partially overlap each other. FIG. 7B illustrates the case where the through hole 803 and the hole 831 completely match each other and the through hole 804 and the hole 832 completely match each other. FIGS. 7A and 7B are examples of the case in which the through hole 804 and the hole 832 are located at the same position.

<Through Hole>

The shape, size, number, and arrangement of the through holes 803 and the through holes 804 in the uppermost layer 801 and the lowermost layer 802, respectively, are not limited to any particular shape, size, number, and arrangement, but may be any appropriately-selected shape, size, number, and arrangement. Some examples are described below.

The through holes 803 in the uppermost layer 801 preferably have an opening ratio of 10% or more and 70% or less when viewed from the upper side in the lamination direction.

The through holes 804 of the lowermost layer 802 preferably have an opening ratio of 10% or more and 70% or less when viewed from the lower side in the lamination direction.

The opening ratio of the through holes 803 when viewed from the upper side in the lamination direction is also referred to as a first opening ratio, and the opening ratio of the through holes 804 when viewed from the lower side in the lamination direction is also referred to as a second opening ratio. Further, the through holes 804 in the uppermost layer 801 may be referred to as first through holes, and the through holes 803 in the lowermost layer 802 may be referred to as second through holes.

In the case where the first opening ratio is 10% or more and 70% or less, the permeability of liquid can be ensured, and fluff fibers can be prevented from coming out from a layer below the uppermost layer 801 via the through holes 803. Fluff fibers may come into contact with a liquid discharge head, and there is a concern that image quality may be affected or the apparatus may fail.

In the case where the first opening ratio is smaller than 10%, the permeability of liquid is lowered, and liquid is less likely to penetrate downward to the depth of one-fifth or more of the thickness of the absorber 811. As a result, liquid dries on the surface of the absorber 811 and is slightly deposited.

In the case where the first opening ratio exceeds 70%, the open area of the through holes 803 is too large. Fluff fibers may slightly come from the layer below the uppermost layer 801 and come into contact with the liquid discharge head.

Similarly, in the case where the second opening ratio is 10% or more and 70% or less, the permeability of liquid can be ensured, and fluff fibers can be prevented from coming out from the layer below the lowermost layer 802 via the through holes 804. Even if fluff fibers come out on the side of the lowermost layer 802, the fluff of fibers does not come into contact with the liquid discharge head. However, in the case where a sheet is used upside down, in other words, in the case where the lowermost layer 802 is used as the uppermost layer, fluff fibers can be prevented from coming into contact with the liquid discharge head.

From the above description, it is more preferable that the through holes 804 in the uppermost layer 801 have an opening ratio (first opening ratio) of 10% or more and 70% or less when viewed from the upper side in the lamination direction, and the through holes 803 in the lowermost layer 802 have an opening ratio (second opening ratio) of 10% or more and 70% or less when viewed from the lower side in the lamination direction. Such a configuration can ensure the permeability of liquid and prevent fluff fibers from coming into contact with the liquid discharge head. There are also advantages of ensuring the permeability of liquid and preventing the contact of fluff fibers even when both sides are used.

The first opening ratio and the second opening ratio may be the same or different from each other.

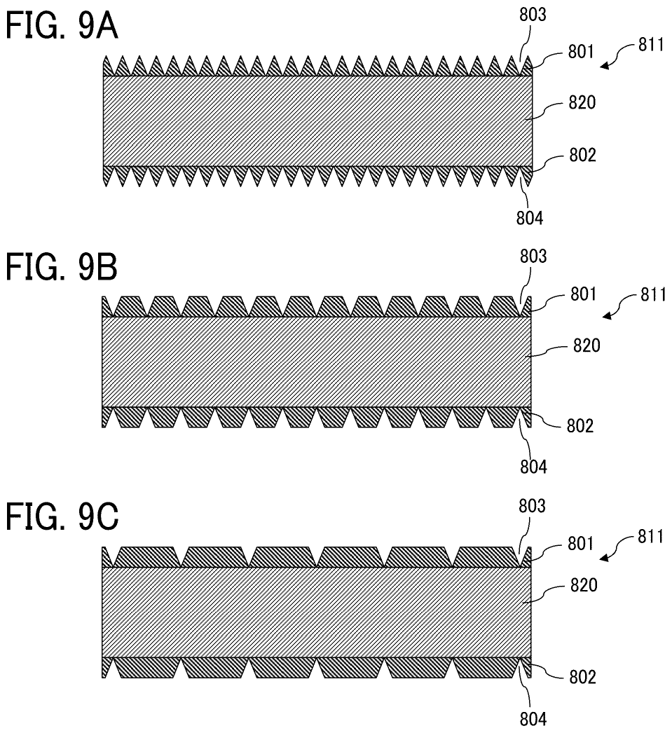

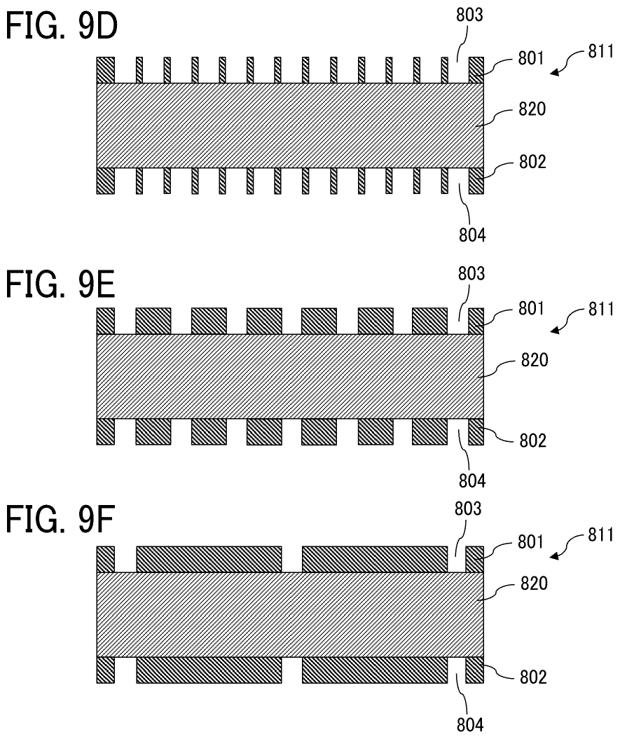

FIGS. 9A to 9C and FIGS. 9D to 9F are diagrams illustrating the opening ratio. FIGS. 9A and 9D are examples in which each of the first opening ratio and the second opening ratio exceeds 70%. FIGS. 9B and 9E are examples in which each of the first opening ratio and the second opening ratio is 10% or more and 70% or less. FIGS. 9C and 9F are examples in which each of the first opening ratio and the second opening ratio is less than 10%. Therefore, FIG. 9B and FIG. 9E are examples in which the opening ratio is 10% or more and 70% or less, and are preferable examples.

The through holes 803 of the uppermost layer 801 preferably have diameters of 1.5 mm or less when viewed from the upper side in the lamination direction, or areas of 1.766 mm² or less when viewed from the upper side in the lamination direction. In this case, the target permeability of liquid can be obtained. For example, the through holes 803 allow liquid to permeate downward by one-fifth or more of the thickness of the absorber 811 and prevent the liquid from being deposited on the surface of the absorber 811. The through holes 803 can also prevent fluff fibers from coming out from a layer below the uppermost layer 801 via the through holes 803.

The through holes 803 of the uppermost layer 801 preferably have diameters of 0.5 mm or more and 1.5 mm or less when viewed from the upper side in the lamination direction, or areas of 0.196 mm² or more and 1.766 mm² or less when viewed from the upper side in the lamination direction. In this case, a more preferable target can be achieved with respect to the permeability of liquid. For example, the through holes 803 allow liquid to permeate downward by one-fifth or more of the thickness of the absorber 811 and prevent the liquid from permeating downward by two-fifths or more of the thickness of the absorber 811. In this case, the through holes 803 can further prevent the liquid from being deposited on the surface of the absorber 811.

When the diameters are larger than 1.5 mm or when the areas are larger than 1.766 mm², fluff fibers may come out from a layer below the uppermost layer 801 via the through holes 803, and come into contact with the liquid discharge head.

It is preferable that the through holes 804 of the lowermost layer 802 also satisfy the same numerical range as described above.

The through holes 804 of the lowermost layer 802 preferably have diameters of 1.5 mm or less when viewed from the lower side in the lamination direction, or areas of 1.766 mm² or less when viewed from the lower side in the lamination direction. In this case, the drying property of the back side of the absorber 811 can be enhanced. Further, in the case where both sides are used, fluff fibers can be prevented from occurring when the lowermost layer 802 is used as the uppermost layer.

The through holes 804 of the lowermost layer 802 preferably have diameters of 0.5 mm or more and 1.5 mm or less when viewed from the lower side in the lamination direction, or areas of 0.196 mm² or more and 1.766 mm² or less when viewed from the lower side in the lamination direction. In this case, the drying property of the back side of the absorber 811 can be further enhanced. Further, when the lowermost layer 802 is used as the uppermost layer in the case where both sides are used, a more preferable target can be achieved with respect to the liquid permeability and the occurrence of fluff fibers can be prevented.

It is particularly preferable that the through holes 803 of the uppermost layer 801 and the through holes 804 of the lowermost layer 802 simultaneously satisfy the above-described numerical ranges.

For example, more preferably, the through holes 803 of the uppermost layer 801 have diameters of 1.5 mm or less or areas of 1.766 mm² or less when viewed from the upper side in the lamination direction, and the through holes 804 of the lowermost layer 802 have diameters of 1.5 mm or less or areas of 1.766 mm² or less when viewed from the lower side in the lamination direction.

For example, particularly preferably, the through holes 803 of uppermost layer 801 have diameters of 0.5 mm or more and 1.5 mm or less or areas of 0.196 mm² or more and 1.766 mm² or less when viewed from the upper side in the lamination direction, and the through holes 804 of lowermost layer 802 have diameters of 0.5 mm or more and 1.5 mm or less or areas of 0.196 mm² or more and 1.766 mm² or less when viewed from the lower side in the lamination direction.

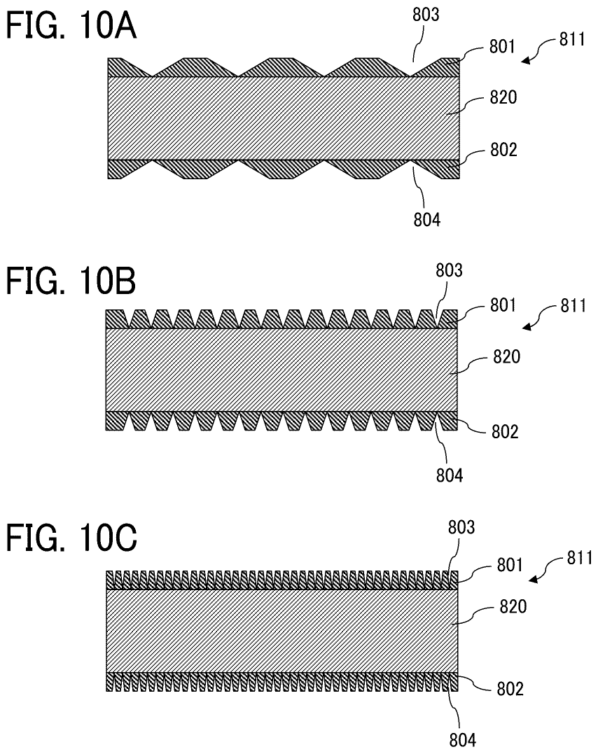

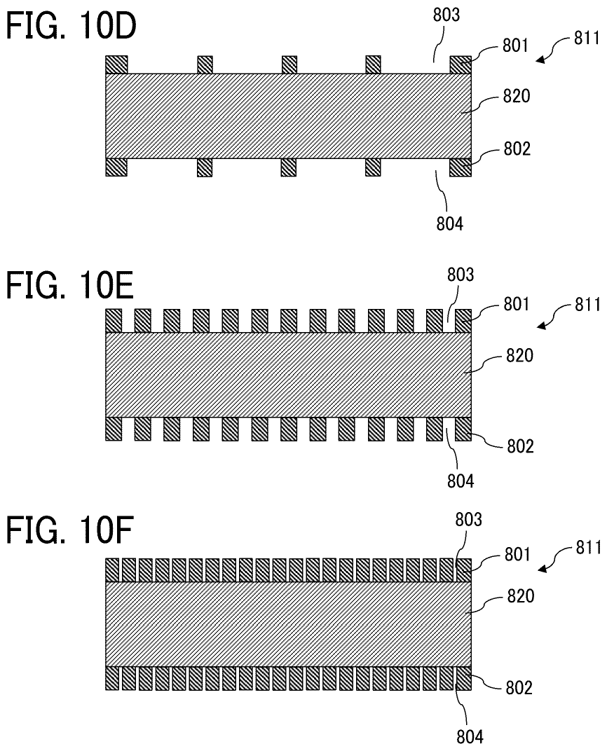

FIGS. 10A to 10C and FIGS. 10D to 10F are diagrams illustrating the sizes of the through holes 803 and 804. FIG. 10A and FIG. 10D are examples in which the diameters of the through holes 803 and 804 exceed 1.5 mm. FIG. 10B and FIG. 10E are examples in which the diameters of the through holes 803 and 804 are 0.5 mm or more and 1.5 mm or less. FIG. 10C and FIG. 10F are examples in which the diameters of the through holes 803 and 804 are less than 0.5 mm. Therefore, FIG. 10B and FIG. 10E are examples in which the diameters are 0.5 mm or more and 1.5 mm or less, and are preferable examples.

The method for measuring the through holes is as follows.

The diameter or the area of the through hole 803 in the uppermost layer 801 is measured when viewed from the upper side in the lamination direction, and the diameter or the area of the through hole 804 in the lowermost layer 802 is measured when viewed from the lower side in the lamination direction. The diameter can be measured using, for example, a vernier caliper or a ruler. The opening ratio can be obtained from the obtained area.

However, since the uppermost layer 801 and the lowermost layer 802 are nonwoven fabrics, it can be said that the uppermost layer 801 and the lowermost layer 802 have a porous structure. The through holes can be distinguished from the others by, for example, visual observation. Also in the measurement of the opening ratio, the opening ratio can be determined by visually distinguishing the through holes from the others.

The arrangement of the through holes 803 and 804 in the uppermost layer 801 and the lowermost layer 802 and the arrangement of the holes 831 and 832 included in the inner layer can be appropriately changed.

Some examples are illustrated in FIGS. 11A to 11C. FIGS. 11A to 11C are schematic plan views of the absorber 811 as viewed from above. Since both sides of the absorber 811 according to the present embodiment can be used, the following description is also applicable to the arrangement of the through holes 804 in the lowermost layer 802. In that case, it can be said that FIGS. 11A to 11C are schematic plan views when the absorber 811 is viewed from below.

In FIG. 11A, the through holes 803 are regularly and evenly arranged. In FIG. 11B, the through holes 803 are arranged in a staggered manner. In FIG. 11C, the through holes 803 are irregularly arranged. As described above, the arrangement of the through holes 803 and 804 in the uppermost layer 801 and the lowermost layer 802 can be appropriately changed.

Similarly, for example, the arrangement of the holes 831 and 832 included in the inner layer can be appropriately changed. FIGS. 11A to 11C are schematic plan views of the uppermost layer 801, but may be schematic plan views of an inner layer as viewed from above. In this case, the through hole 803 may be read as the hole 831. FIGS. 11A to 11C illustrate the examples in which the through hole 803 and the hole 831 are disposed at the same position, which are indicated by the reference numerals 803 and 831 in FIGS. 11A to 11C. As described above, the positions of the through hole 803 and the hole 831 are preferably the same, but may not be the same.

Further, FIGS. 11A to 11C are schematic plan views of the uppermost layer 801, but may be schematic plan views of an inner layer as viewed from below. In this case, the through hole 803 may be read as the hole 832. The positions of the through hole 804 and the hole 832 are preferably the same, but may not be the same.

The shapes of the through holes 803 and 804 and the holes 831 and 832 may be circular as illustrated in FIGS. 11A to 11C or may be other shapes. Examples of the other shapes include, but are not limited to, a triangular shape, a quadrangular shape, and a star shape.

<Joining of Uppermost Layer and Lowermost Layer to Inner Layer>

The uppermost layer 801 and the lowermost layer 802 are preferably joined to the inner layer.

In the inner layer, when a layer in contact with the uppermost layer 801 is referred to as a first inner layer and a layer in contact with the lowermost layer 802 is referred to as a second inner layer, it is preferable that the uppermost layer 801 and the first inner layer are bonded or fixed by a heat-fusible substance, and the lowermost layer 802 and the second inner layer are bonded or fixed by a heat-fusible substance. However, the first inner layer and the second inner layer may be the same layer.

Such a configuration can prevent the uppermost layer 801 and the lowermost layer 802 from separating from the inner layer, and facilitate handling of the absorber 811, for example, on replacement of the absorber 811, thus enhancing maintainability. Further, since the uppermost layer 801 and the lowermost layer 802 can be prevented from separating from the inner layer, the liquid permeability and drying properties can be prevented from being impaired. Examples of the above-mentioned joining include bonding and fixation.

Examples of the heat-fusible substance include hot-melt adhesives, heat-fusible fibers, and heat-fusible powders. The heat-fusible fibers and the heat-fusible powder may be mixed and used.

The method of bonding or fixing with the heat-fusible substance may be any appropriately-selected method. For example, heat is applied to the inner layer and the uppermost layer 801 or the lowermost layer 802 via hot-melt adhesive or heat-fusible powder to join the inner layer and the uppermost layer 801 or the lowermost layer 802.

<Evaluation>

A description is given of several evaluations performed on the above-described numerical range. The results are described below.

The samples of the absorber used for the evaluations had three layers of the uppermost layer, the inner layer (one layer), and the lowermost layer, and had the configuration illustrated in Table 1 below. The inner layer was a dry nonwoven fabric web mainly including natural cellulose fibers.

<<Evaluation of Generation of Fluff Fibers>>

Whether fluff fibers are generated on the sample surface is visually observed. The evaluation criteria are as follows. A level of B or higher is regarded as a level not problematic in practical use.

Evaluation Criteria
A: No fluff fibers are generated.
B: Fluff fibers are generated in places.
C: Fluff fibers are generated on almost the entire surface.

<<Evaluation of Penetration Depth>>

A model ink (pigmented ink prepared based on the disclosure of Japanese Unexamined Patent Application Publication No. 2020-(49937) was filled in a disposable syringe (Terumo Syringe SS-20ESZP), and a syringe needle (attached to Terumo Syringe SS-01T2613S) was attached to perform gas-liquid extraction. In the environment adjusted to 32° C. and 30% relative humidity (RH), the disposable syringe filled with the ink was installed to a syringe pump such that the extrusion direction of the syringe be horizontal to the laboratory bench, and the ink was dropped onto the absorber for 15 hours under a dropping condition of 0.5 μl/min. The cross-section of the absorber after the dropping was cut, and the extent of penetration into the absorber was evaluated according to the following evaluation criteria. C or higher is a level that is not problematic in practical use.

Evaluation Criteria
A: Ink penetrates up to one-fifth to two-fifths of the thickness of the absorber.
B: Ink penetrates to one-fifth or less of the thickness of the absorber (in other words, hardly penetrates).
C: Ink penetrates up to two-fifths to one-half of the thickness of the absorber.
D: Ink penetrates to one-half or more of the thickness of the absorber (in other words, penetrates too much).

One-fifth of the thickness of the absorber is a point at one-fifth of the thickness of the absorber downward from the outermost surface of the absorber. In other words, the outermost surface of the absorber is defined as a base point.

Evaluation of Deposition Property

A model ink (pigmented ink prepared based on the disclosure of Japanese Unexamined Patent Application Publication No. 2020-049937) was filled in a disposable syringe (Terumo Syringe SS-20ESZP), and a syringe needle (attached to Terumo Syringe SS-01T2613S) was attached to perform gas-liquid extraction. In the environment adjusted to 32° C. and 30% relative humidity (RH), the disposable syringe filled with the ink was installed to a syringe pump such that the extrusion direction of the syringe be horizontal to the laboratory bench, and the ink was dropped onto the absorber for 15 hours under a dropping condition of 0.5 μl/min. Whether ink is deposited on the absorber after the dropping was checked, and the deposition property was evaluated according to the following evaluation criteria C or higher is a level not problematic in practical use.

Evaluation Criteria
A: Ink is absorbed by the absorber and is not deposited.
B: Ink partially remains on the absorber but has fluidity and is not deposited.
C: ink is slightly deposited on the absorber.
D: Ink on the absorber has almost no fluidity and is deposited.

The results are presented in Table 1. In Table 1, the term “sheet layer” means the uppermost layer and the lowermost layer. In this evaluation, the uppermost layer and the lowermost layer had the same configuration. In Table 1, the depth of hole in the inner layer is the same between the uppermost-layer side and the lowermost-layer side. The numerical values in Table 1 (including Table 1-1 and Table 1-2) were measured as described above.

TABLE 1

Inner layer

| | | Apparent | | |
|---|---|---|---|---|
| | Production method | density | Thickness | Depth of |
| | of inner layer | [g/cm³] | [mm] | hole [mm] |
| Example 1 | Air-laid production | 0.10 | 9.0 | 1.0 |
| | method | | | |
| Example 2 | Air-laid production | 0.10 | 9.0 | 1.0 |
| | method | | | |
| Example 3 | Air-laid production | 0.07 | 9.0 | 1.0 |
| | method | | | |
| Example 4 | Air-laid production | 0.60 | 9.0 | 1.0 |
| | method | | | |
| Example 5 | Air-laid production | 0.10 | 9.0 | 1.0 |
| | method | | | |
| Example 6 | Air-laid production | 0.10 | 9.0 | 1.0 |
| | method | | | |
| Example 7 | Air-laid production | 0.10 | 4.4 | 1.0 |
| | method | | | |
| Example 8 | Air-laid production | 0.10 | 9.0 | 4.0 |
| | method | | | |
| Example 9 | Air-laid production | 0.10 | 9.0 | 1.0 |
| | method | | | |
| Example 10 | Air-laid production | 0.10 | 9.0 | 1.0 |
| | method | | | |
| Example 11 | Air-laid production | 0.10 | 9.0 | 1.0 |
| | method | | | |
| Example 12 | Thermal bonding | 0.10 | 9.0 | 1.0 |
| | production method | | | |
| Comparative | Air-laid production | 0.08 | 9.0 | 1.0 |
| example 1 | method | | | |
| Comparative | Air-laid production | 0.10 | 9.0 | 1.0 |
| example 2 | method | | | |

| | Sheet layer | | | | | |
|---|---|---|---|---|---|---|
| | | Opening | Size (area) | | | Occurrence |
| | Thickness | ratio | of through | Hight of | Depth of | of fluff |
| | [mm] | [%] | hole [mm²] | deposition | permeation | fibers |
| Example 1 | 0.5 | 10 | 1.5 | A | A | A |
| Example 2 | 0.5 | 10 | 0.1 | B | A | A |
| Example 3 | 0.5 | 20 | 1.5 | A | C | A |
| Example 4 | 0.5 | 20 | 1.5 | C | B | A |
| Example 5 | 0.2 | 30 | 1.5 | A | C | A |
| Example 6 | 0.9 | 30 | 1.5 | C | B | A |
| Example 7 | 0.5 | 40 | 1.5 | A | C | A |
| Example 8 | 0.5 | 40 | 1.5 | A | C | A |
| Example 9 | 0.5 | 5 | 1.5 | C | B | A |
| Example 10 | 0.5 | 75 | 1.5 | A | A | B |
| Example 11 | 0.5 | 50 | 1.8 | A | A | B |
| Example 12 | 0.5 | 10 | 1.5 | B | B | A |
| Comparative | 0.5 | 20 | Front side: 1.5 | A | D | A |
| example 1 | | | Back side: 0 | | | |
| Comparative | 0.5 | 20 | Front side: 0 | D | A | A |
| example 2 | | | Back side: 1.5 | | | |

From the results of Table 1, for example, the following can be seen.

From the results of Examples 3 and 4, preferably, the apparent density of the inner layer is 0.08 g/cm³ or more and 0.50 g/cm³ or less.

From the results of Examples 5 and 6, the thickness of each of the uppermost layer and the lowermost layer is preferably 0.3 mm or more and 0.8 mm or less.

From the results of Example 7, the thickness of the inner layer is preferably 4.5 mm or more.

From the results of Example 8, the depth of the hole in the inner layer is preferably one-third or less of the thickness of the inner layer.

From the results of Examples 9 and 10, the opening ratio is preferably 10% or more and 70% or less. The opening ratio corresponds to the first opening ratio and the second opening ratio.

From the results of Examples 2 and 11, the area of the through hole is preferably 0.196 mm² or more and 1.766 mm² or less.

From the results of Examples 1 and 12, the production method of the inner layer is preferably an air-laid production method.

In Comparative Example 1, the uppermost layer has through holes, but the lowermost layer have no through holes. As a result, the drying effect is weakened, and liquid penetrates too much.

In Comparative Example 2, the lowermost layer has through holes, but the uppermost layer has no through holes. As a result, the permeation effect of liquid is weakened and the liquid is deposited.

<Detailed Example of Liquid Receiver>

A description is given below of a liquid receiver according to an embodiment of the present disclosure.

The liquid receiver includes an absorber according to an embodiment of the present disclosure. Preferably, the absorber included in the liquid receiver of the present embodiment is divided into multiple pieces. The divided pieces of the absorber are also referred to as, for example, blocks. The absorber of the present embodiment can enhance the maintainability. In addition, since the absorber is divided, only a block that needs to be replaced can be replaced. Thus, the maintainability is further enhanced.

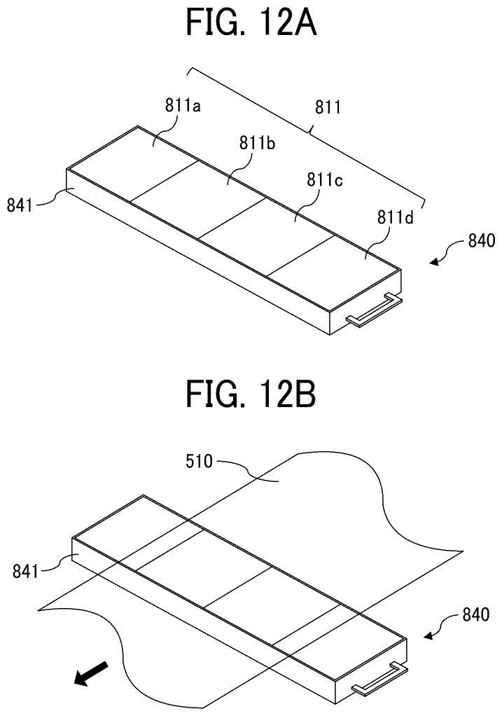

FIGS. 12A and 12B are schematic perspective views of a liquid receiver 840 according to an embodiment of the present disclosure. In the example illustrated in FIGS. 12A and 12B, the absorber 811 is divided into absorber portions 811a, 811b, 811c, and 811d. The absorber portions 811a to 811d may be referred to as, for example, blocks.

In FIG. 12A, the absorber 811 is divided into the absorber portions 811a to 811d that are arranged side by side. The absorber portions 811a to 811d are accommodated in a tray 841. The tray 841 is an example of a storage container.

In FIG. 12B, the conveyance direction of a sheet medium 510 is indicated by a black arrow in the drawing. As illustrated in FIG. 12B, the divided absorber portions 811a to 811d are arranged side by side in a direction (planar direction) orthogonal to the conveyance direction.

For example, the absorber 811 is divided into multiple blocks in a plane on which dummy discharge droplets are discharged to land, and the blocks are arranged in the tray 841. The blocks are arranged with side faces of the blocks in contact with each other. In FIG. 12B, the absorber 811 is divided into individual blocks.

The liquid receiver 840 according to an embodiment of the present disclosure may have a holder disposed below the lowermost layer of the absorber 811 such that the holder is in contact with the lowermost layer. Further, the holder is preferably made of metal, and more preferably made of sheet metal. In addition, preferably, the holder is subjected to anti-rust treatment and has a claw that fixes the absorber 811 from a side surface of the absorber 811.

Such a holder can favorably fix the absorber 811 and facilitate removal of the absorber 811, thus enhancing maintainability. Further, since anti-rust treatment is performed, rust is less likely to occur even when liquid comes into contact with the holder, and durability is enhanced.

The holder may be made of metal or resin. In the case where the holder is made of metal to prevent corrosion due to liquid (for example, ink), it is preferable to use a steel use stainless (SUS) material having high corrosion resistance or a material subjected to anti-rust treatment. The method of the anti-rust treatment is not limited to any particular method, and may be, for example, organic coating, inorganic coating, or electrolytic protection.

Further, the holder may be formed of a meshed or porous plate material. Such a configuration can increase the air permeability from the lower side of the holder and promote drying of the absorber 811.

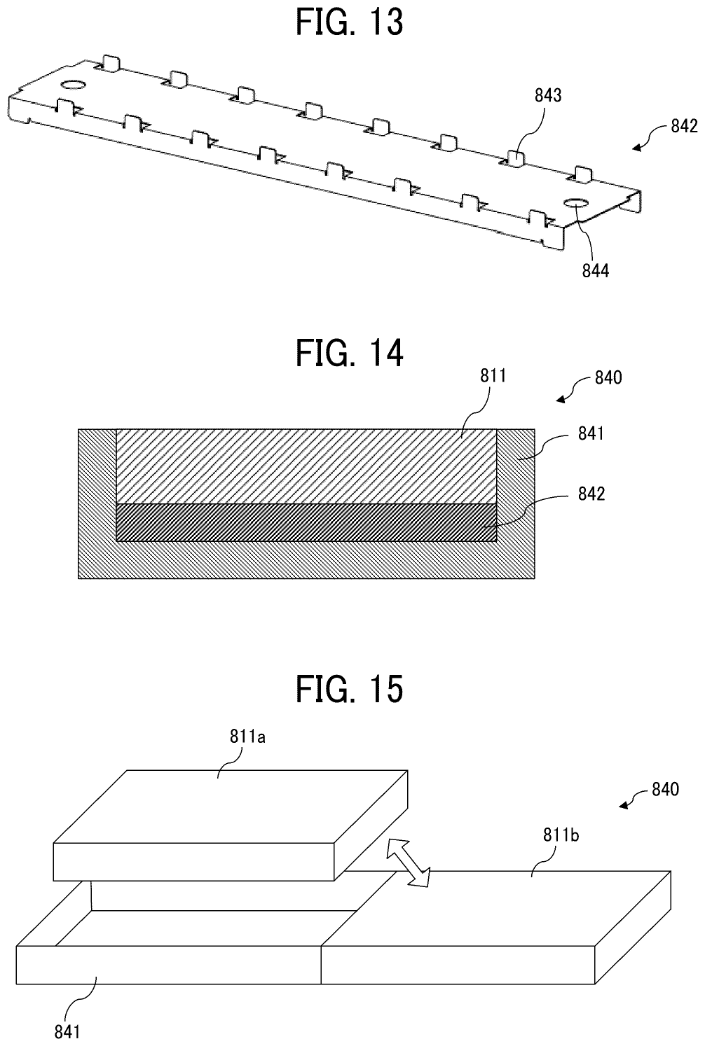

FIG. 13 is a schematic perspective view of a holder 842 according to an embodiment of the present disclosure. The holder 842 is formed of a sheet metal. As illustrated in FIG. 13, the holder 842 has claws 843. The claws 843 fixe the absorber 811 from side faces of the absorber 811. The fixing of the absorber 811 from the side faces does not require that the absorber 811 does not move or shift at all when the absorber 811 is installed in the holder 842, and may be that the absorber 811 is fixed to the extent that the absorber 811 does not fall from the holder 842. The fixing may be expressed by the phrase that the claws 843 support the absorber 811.

FIG. 14 is a schematic cross-sectional view of a liquid receiver 840 according to an embodiment of the present disclosure. As illustrated in FIG. 14, a tray 841 houses the absorber 811 and the holder 842. As described above, liquid is absorbed into the absorber 811 with the absorber 811 and the holder 842 accommodated in the tray 841.

In FIG. 14, claws 843 of the holder 842 are not illustrated.

Further, as illustrated in FIG. 13, the holder 842 has a hole 844. The hole 844 facilitates removal of the holder 842 from the tray 841. The holder 842 has the hole 844 into which an end of the sheet medium 510 in the direction orthogonal to the conveyance direction can be inserted.

Further, the holder 842 may have projecting portions on a surface facing the absorber 811. With the projecting portions, holes are further opened in the bottom surface of the absorber 811, thus enhancing drying property. In addition, the absorber 811 is stably secured on the holder 842. Such projecting portions are not limited to any particular shape, but is preferably, for example, a pointed shape.

The holder 842 may not only fix the absorber 811 but also adjust the height of the absorber 811. For example, a space may be provided between the holder 842 and the tray 841 to raise the position of the absorber 811. A spare absorber 811 may be stored in the space between the holder 842 and the tray 841.

As illustrated in FIG. 12B, the absorber 811 is divided in a direction (planar direction) orthogonal to the conveyance direction of the sheet medium 510. The direction orthogonal to the conveyance direction of the sheet medium 510 is also referred to as a longitudinal direction of the liquid receiver 840. The absorber 811 is preferably divided into at least three or more blocks in the longitudinal direction. The absorber 811 may also be divided not only in the longitudinal direction but also in the lateral direction (i.e., a direction parallel to the conveyance direction of the sheet medium 510).

As the absorber 811 is more finely divided, a portion that absorbs liquid and a portion that does not absorb liquid can be separated from each other. As a result, the absorption efficiency of the absorber 811 can be enhanced, and the replacement frequency of the absorber 811 can be reduced. In the example illustrated in FIGS. 12A and 12B, the absorber 811 is divided into four blocks in the longitudinal direction.

FIG. 15 is a schematic view of the absorber 811 in the case where the blocks of the absorber 811 are partially replaced. FIG. 15 illustrates a state in which a block of the absorber 811 to be replaced, for example, the absorber portion 811a in FIG. 15 is removed from the tray 841. For example, the absorber portion 811a and the absorber portion 811b are replaced. It may be referred that the absorber portion 811a and the absorber portion 811b are exchanged. Replacing a block (e.g., the absorber portion 811a) in which a large amount of liquid is deposited with a block (e.g., the absorber portion 811b) in which a small amount of liquid is deposited can obviate the necessity of replacing all the absorber portions of the absorber 811. Thus, the absorber 811 can be used for a long time. The double-headed arrow in FIG. 15 schematically indicates the replacement of the blocks of the absorber 811.

The absorber and the liquid receiver according to an embodiment of the present disclosure receive and absorb a liquid that does not contribute to image formation. The liquid that does not contribute to image formation is discharged, for example, as maintenance of the liquid discharge head. In the maintenance of the liquid discharge head, for example, a liquid that does not contribute to image formation, such as ink, is dummy-discharged. The absorber and the liquid receiver of the present disclosure receive the dummy discharge droplets discharged by the dummy discharge. The absorber and the liquid receiver according to an embodiment of the present disclosure can absorb not only the dummy discharge liquid but also the liquid which is generated from the liquid discharging apparatus and does not contribute to the image formation.

The liquid that does not contribute to image formation may be referred to as, for example, waste ink or waste liquid. The terms “image formation”, “recording”, “printing”, “image printing”, and “fabricating” used herein may be used synonymously with each other.

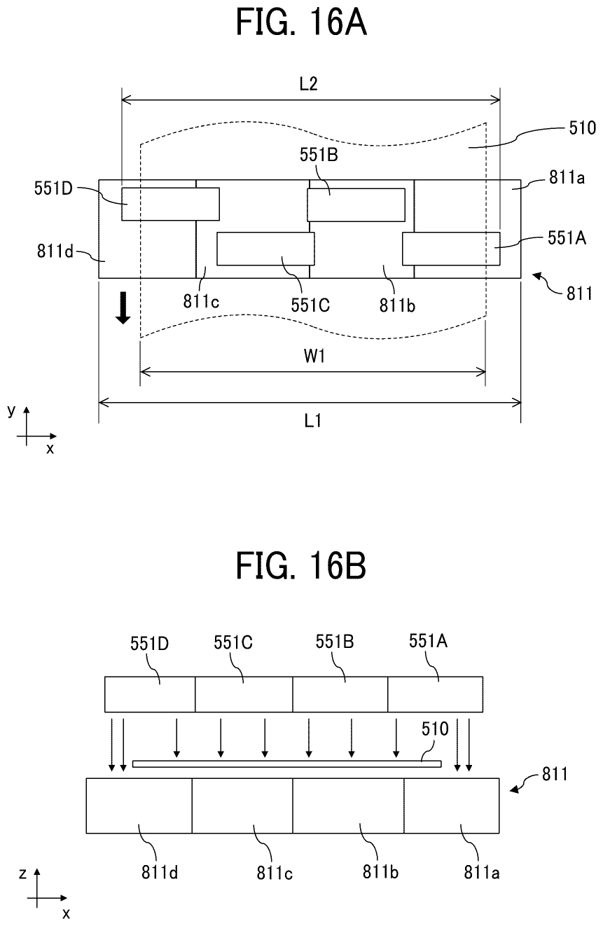

FIGS. 16A and 16B are diagrams illustrating the arrangement of an absorber 811 according to an embodiment of the present disclosure. FIG. 16A is a schematic plan view of the absorber 811. FIG. 16B is a schematic side view of the absorber 811. In FIG. 16A, the conveyance direction of the sheet medium 510 is indicated by an arrow. In FIG. 16B, the liquid discharged by the head arrays 551A to 551D is indicated by arrows. The coordinates in FIGS. 16A and 16B are illustrated for the sake of explanation. Further, the absorber 811 according to the present embodiment is divided in the same manner as the above-described embodiment.

In an apparatus that performs printing on a sheet medium 510 such as continuous paper, liquid is discharged with the sheet medium 510 facing the head. As a result, in a region where the sheet medium 510 is not interposed between the absorber 811 and the head, the liquid discharged from the head does not land on the sheet medium 510 but lands on the absorber 811. Liquid droplets that do not land on the sheet medium 510 are also referred to as dummy discharge droplets, and discharging dummy discharge droplets is also referred to as dummy discharge.

The size and arrangement of the absorber 811 are not limited to any particular size and arrangement, but may be any appropriately-selected size and arrangement. For example, as illustrated in FIG. 16A, the length L1 of the absorber 811 in the longitudinal direction of the absorber 811 is longer than the length L2 of the head in the direction in which the head arrays 551A to 551D are arranged (i.e., the direction orthogonal to the conveyance direction). When the sheet medium 510 having a width W1 is conveyed on the center basis, dummy discharge droplets land only on both end portions of the absorber 811. As illustrated in FIG. 16B, dummy discharge droplets land on the absorber portion 811a and the absorber portion 811d that are both end portions of the absorber 811.

In the case where a liquid which is easily dried or deposited, such as a liquid having a high viscosity, is used, there is a concern that the deposition may progress at both end portions of the absorber 811 as dummy discharge is repeated. If the deposition proceeds, the replacement of the absorber 811 may be needed.

The absorber 811 according to the present embodiment is divided into multiple blocks in the direction orthogonal to the conveyance direction of the sheet medium 510. Accordingly, depending on the manner of facing the head and whether ink is deposited on the sheet medium 510, the absorber 811 is divided into blocks on which dummy discharge droplets land and blocks on which the dummy discharge droplets do not land. As a result, when the absorber 811 is replaced, blocks (for example, the absorber portions 811a and 811d) on which dummy discharge droplets land are replaced with blocks (for example, the absorber portions 811b and 811c) on which the dummy discharge droplets do not land. Thus, the absorber 811 can be used as an unused absorber. The block to be replaced may be separately replaced with an unused block.

Such replacement is further described below. For example, as illustrated in FIG. 15, the absorber portion 811a and the absorber portion 811b may be exchanged. For example, in the case where dummy discharge droplets land on the absorber portion 811a and the dummy discharge droplet does not land on the absorber portion 811b, exchanging the absorber portion 811a and the absorber portion 811b allows use of the absorber portion 811b in which no liquid is deposited at positions where dummy discharge droplets land.

A description is given of some aspects of the present disclosure.

Initially, a description is given of a first aspect.

An absorber absorbs liquid discharged from a liquid discharge head. The absorber includes three or more laminated layers. An uppermost layer of the laminated layers is made of nonwoven fabric and has through holes penetrating through the uppermost layer in a lamination direction in which the laminated layers are laminated. A lowermost layer of the laminated layers is made of nonwoven fabric and has through holes penetrating through the lowermost layer in the lamination direction. An inner layer of the laminated layers has a porous structure having a higher liquid absorption capacity than each of the uppermost layer and the lowermost layer.

A description is given of a second aspect.

The absorber according to the first aspect absorbs a liquid that does not contribute to image formation.

A description is given of a third aspect.

In the absorber according to the first or second aspect, the inner layer is a dry nonwoven fabric web or a dry nonwoven fabric mat containing natural cellulose fibers and has an apparent density of 0.08 g/cm³ or more and 0.50 g/cm³ or less.

A description is given of a fourth aspect.

In the absorber according to any one of the first to three aspects, each of the uppermost layer and the lowermost layer has a thickness of 0.3 mm or more and 0.8 mm or less.

A description is given of a fifth aspect.

In the absorber according to any one of the first to fourth aspects, the inner layer has a thickness of 4.5 mm or more.

A description is given of a sixth aspect.

In the absorber according to any one of the first to fifth aspects, the inner layer is an air-laid nonwoven fabric.

A description is given of a seventh aspect.

In the absorber according to any one of the first to fifth aspects, the inner layer has holes on a surface facing the uppermost layer and a surface facing the lowermost layer. The holes do not penetrate through the inner layer and have a depth of one-third or less with respect to a thickness of the inner layer.

A description is given of an eighth aspect.

In the absorber according to the seventh aspect, the holes on the surface of the inner layer facing the uppermost layer are at the same positions as the through holes of the uppermost layer. The holes on the surface of the inner layer facing the lowermost layer are at the same positions as the through holes of the lowermost layer.

Now, a description is given of a ninth aspect.

In the absorber according to any one of the first to eighth aspects, the through holes of the uppermost layer have an opening ratio of 10% or more and 70% or less when viewed from above in the lamination direction. The through holes of the lowermost layer have an opening ratio of 10% or more and 70% or less when viewed from below in the lamination direction.

A description is given of a tenth aspect.

In the absorber according to any one of the first to ninth aspects, each one of the through holes of the uppermost layer has a diameter of 1.5 mm or less when viewed from above in the lamination direction or an area of 1.766 mm² or less when viewed from above in the lamination direction. Each one of the through holes of the lowermost layer has a diameter of 1.5 mm or less when viewed from below in the lamination direction or an area of 1.766 mm² or less when viewed from below in the lamination direction.

A description is given of an eleventh aspect.

In the absorber according to the tenth aspect, each one of the through holes of the uppermost layer has a diameter of 0.5 mm or more and 1.5 mm or less when viewed from above in the lamination direction or an area of 0.196 mm² or more and 1.766 mm² or less when viewed from above in the lamination direction. Each one of the through holes of the lowermost layer has a diameter of 0.5 mm or more and 1.5 mm or less when viewed from below in the lamination direction or an area of 0.19 mm² or more and 1.766 mm² or less when viewed from below in the lamination direction.

A description is given of a twelfth aspect.

In the absorber according to any one of the first to eleventh aspects, when a layer in contact with the uppermost layer is defined as a first inner layer and a layer in contact with the lowermost layer is defined as a second inner layer in the inner layer, the uppermost layer and the first inner layer are bonded or fixed by a heat-fusible substance, and the lowermost layer and the second inner layer are bonded or fixed by a heat-fusible substance.

However, the first inner layer and the second inner layer may be the same layer.

A description is given of a thirteenth aspect.

A liquid receiver includes the absorber according to any one of the first to twelfth aspects. The absorber is divided.

A description is given of a fourteenth aspect.

A liquid receiver includes: the absorber according to any one of the first to thirteenth aspects; a holder below and in contact with the lowermost layer; and a container that accommodates the absorber and the holder. The absorber is divided to absorb the liquid, with the absorber and the holder accommodated in the container.

A description is given of a fifteenth aspect.

A liquid receiver includes: the absorber according to any one of the first to twelfth aspects; and a holder below and in contact with the lowermost layer. The holder is made of metal and is subjected to anti-rust treatment. The holder has a claw to fix the absorber from a side face of the absorber.

A description is given of a sixteenth aspect.

A liquid discharge apparatus includes: the absorber according to any one of the first to twelfth aspects or the liquid receiver according to any one of the twelfth to fourteenth aspects; and a liquid discharger to discharge liquid.

A description is given of a seventeenth aspect.

In the liquid discharge apparatus according to the sixteenth aspect, the absorber absorbs liquid discharged by maintenance of the liquid discharger.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

1. An absorber for absorbing liquid discharged from a liquid discharge head, the absorber comprising three or more laminated layers,
the three or more laminated layers including:
an uppermost layer of nonwoven fabric having through holes that penetrate through the uppermost layer in a lamination direction in which the laminated layers are laminated;
a lowermost layer of nonwoven fabric having through holes that penetrate through the lowermost layer in the lamination direction; and
an inner layer between the uppermost layer and the lowermost layer, the inner layer having a porous structure higher in liquid absorption capacity than each of the uppermost layer and the lowermost layer.

2. The absorber according to claim 1,
wherein the absorber absorbs liquid not contributing to image formation.

3. The absorber according to claim 1,
wherein the inner layer is a dry nonwoven fabric web or a dry nonwoven fabric mat containing natural cellulose fibers and has an apparent density of 0.08 g/cm³ or more and 0.50 g/cm³ or less.

4. The absorber according to claim 1,
wherein each of the uppermost layer and the lowermost layer has a thickness of 0.3 mm or more and 0.8 mm or less.

5. The absorber according to claim 1,
wherein the inner layer has a thickness of 4.5 mm or more.

6. The absorber according to claim 1,
wherein the inner layer is an air-laid nonwoven fabric.

7. The absorber according to claim 1,
wherein the inner layer has holes on a surface facing the uppermost layer and a surface facing the lowermost layer, and
wherein the holes have a depth of one-third or less with respect to a thickness of the inner layer without penetrating through the inner layer.

8. The absorber according to claim 7,
wherein the holes on the surface of the inner layer facing the uppermost layer are at same positions as the through holes of the uppermost layer, and the holes on the surface of the inner layer facing the lowermost layer are at same positions as the through holes of the lowermost layer.

9. The absorber according to claim 1,
wherein the through holes of the uppermost layer have an opening ratio of 10% or more and 70% or less when viewed from above in the lamination direction, and the through holes of the lowermost layer have an opening ratio of 10% or more and 70% or less when viewed from below in the lamination direction.

10. The absorber according to claim 1,
wherein each one of the through holes of the uppermost layer has a diameter of 1.5 mm or less when viewed from above in the lamination direction or an area of 1.766 mm² or less when viewed from above in the lamination direction, and
wherein each one of the through holes of the lowermost layer has a diameter of 1.5 mm or less when viewed from below in the lamination direction or an area of 1.766 mm² or less when viewed from below in the lamination direction.

11. The absorber according to claim 10,
wherein each one of the through holes of the uppermost layer has a diameter of 0.5 mm or more and 1.5 mm or less when viewed from above in the lamination direction or an area of 0.196 mm² or more and 1.766 mm² or less when viewed from above in the lamination direction, and
wherein each one of the through holes of the lowermost layer has a diameter of 0.5 mm or more and 1.5 mm or less when viewed from below in the lamination direction or an area of 0.196 mm² or more and 1.766 mm² or less when viewed from below in the lamination direction.

12. The absorber according to claim 1,
wherein the inner layer includes a first inner sub-layer in contact with the uppermost layer and a second inner sub-layer in contact with the lowermost layer, and
wherein the uppermost layer and the first inner sub-layer are bonded or fixed by a heat-fusible substance, and the lowermost layer and the second inner sub-layer are bonded or fixed by a heat-fusible substance.

13. The absorber according to claim 1,
wherein the uppermost layer and the inner layer are bonded or fixed by a heat-fusible substance, and the lowermost layer and the inner layer are bonded or fixed by a heat-fusible substance.

14. A liquid receiver comprising the absorber according to claim 1,
wherein the absorber is divided.

15. A liquid receiver comprising:
the absorber according to claim 1;
a holder below and in contact with the lowermost layer; and
a container that accommodates the absorber and the holder,
wherein the absorber is divided, and absorbs the liquid with the absorber and the holder accommodated in the container.

16. A liquid receiver comprising:
the absorber according to claim 1; and
a holder below and in contact with the lowermost layer,
wherein the holder comprises metal and is subjected to anti-rust treatment, and
wherein the holder has a claw to fix the absorber from a side face of the absorber.

17. A liquid discharge apparatus, comprising:
the absorber according to claim 1; and
a liquid discharger to discharge liquid.

18. The liquid discharge apparatus according to claim 17,
wherein the absorber absorbs liquid discharged by maintenance of the liquid discharger.
